(19) United States
(12) Patent Application Publication
(10) Pub. No.: US 2019/0220750 A1
(43) Pub. Date: Jul. 18, 2019

(54) SOLUTION SEARCH PROCESSING APPARATUS AND SOLUTION SEARCH PROCESSING METHOD

(71) Applicant: HITACHI, LTD., Tokyo (JP)

(72) Inventors: Yosuke FUJIWARA, Tokyo (JP); Yoshiyasu TAKAHASHI, Tokyo (JP); Yuichi KOBAYASHI, Tokyo (JP); Tomoichi EBATA, Tokyo (JP); Taichi ISHITOBI, Tokyo (JP); Yasuharu NAMBA, Tokyo (JP)

(73) Assignee: HITACHI, LTD., Tokyo (JP)

(21) Appl. No.: 16/156,300

(22) Filed: Oct. 10, 2018

(30) Foreign Application Priority Data
Jan. 12, 2018 (JP) 2018-003124

(51) Int. Cl. G06N 3/12; G06N 5/04

(52) U.S. Cl. CPC G06N 3/126; G06N 5/048

(57) ABSTRACT

An action-value function initializing unit inputs search information including a history of a solution, a constraint equation, and an initial state of a selectable domain of a decision variable, sets a decision variable selected in each step and a value of the decision variable as a policy, and initializes an action-value function including the policy, a selectable domain of a decision variable before policy decision, and a selectable domain of a decision variable after the policy decision as parameters. A search unit receives information of the action-value function initialized by the action-value function initializing unit, obtains a value of a corresponding action-value function from the policy, the domain of the decision variable before the policy decision, and a domain of the action-value function after the policy decision, searches for a policy in which the action-value function is largest, and searches for an optimum solution for the problem information.

### BACKGROUND OF INVENTION

The present invention relates to a solution search processing apparatus, and more particularly, to a solution search processing apparatus and a solution search processing method which are suitable for obtaining a quasi-optimum solution corresponding to an optimum solution in a process of searching for a constraint satisfaction solution in a large-scale discrete optimization problem.

As an application of a problem of searching for a constraint satisfaction solution by constraint programming, there are cases in which it is intended for businesses of management and planning of resources in industrial fields such as railroad or resource placement and factory production planning.

As target businesses, for example, in a railroad operation management business, it is required to cause trains to travel on the basis of a predetermined train operation plan (schedule) at a normal time, but when the schedule is disrupted on the day of operation, it is necessary to correct the plan so that there is no obstacle to the train operation. The plans necessary for the railroad transportation include vehicle operation information specifying a vehicle allocation plan for trains on the schedule and crew operation information specifying crew allocation plan in addition to the train schedule. In a case in which the schedule is disrupted on the day of operation, the vehicle operation information or the crew operation information is corrected in accordance with the correction of the scheduled.

Further, for example, in the resource placement planning business, it is requested to prepare a daily plan for placing resources in resource placement places having a capacity limitation in accordance with an inventory amount of resources that changes daily in accordance with receipt/shipment of resources. At this time, it is necessary to prepare the daily plane so that the previous day's plane is not changed as much as possible while complying with many constraints such as a constraint of processing resources for shipment at a predetermined place at a predetermined time and a constraint to a capacity limitation of means for moving resources daily.

In the planning businesses described above, it is required to derive a solution to a large-scale constraint satisfaction problem, and in the past, it has been manually done by a skilled operator. However, in recent years, with the retirement of experienced operators, there is a demand for replacing the above-mentioned businesses with systems. In the systems that replace the businesses of the operators who are skilled operators, it is required to solve a practical constraint satisfaction solution within a practical time with a level equivalent to the plan prepared by the operator.

Techniques that facilitate solving the practical constraint satisfaction solutions have been proposed so far. For example, JP 2003-99259 A discloses a technique in which, whenever a new request such as domain change of a decision variable is added by a user, comparison with a solution employed in a previous problem-solving case is performed, evaluation values of solution candidates are obtained on the basis of a frequency of employment of the same solution, and a solution having the highest evaluation value while satisfying fixed constraints and the addition request is output.

Further, the paper by Marc Vilain et al. (Marc Vilain, Henry Kautz, “Constraint Propagation Algorithms for Temporal Reasoning”, Aaai, 1986, pp 377-382) discloses a technique called constraint programming as one of programming paradigms for performing a tree search efficiently.

### SUMMARY OF THE INVENTION

In the technique described in JP 2003-99259 A, it is possible to perform the comparison with the solution employed in the previous problem-solving case in response to the request regarding the change of the domain of the decision variable input by the user and output an appropriate solution. Here, the domain is a range of values which can be taken as the decision variable. Certainly, the technique described in JP 2003-99259 A is effective because a desired solution is output on the basis of the previous case in a case in which a full search ends in a small-scale constraint satisfaction problem. However, in a large-scale constraint satisfaction problem with a large number of constraints or decision variables, it is difficult to search for a set of constraint satisfaction solutions depending on a situation of a problem setting. In a case in which a tree search in which the decision variable is set as a node, and a value of the decision variable is set as an edge is performed in the large-scale decision constraint satisfaction problem, it is difficult to perform a full search within a practical time, and it is necessary to set an appropriate search rule in accordance with a change in a constraint equation as well as a the domain change of the decision variable so that a solution can be obtained within the number of search steps in which a search can be performed within a practical time.

Further, in the constraint programming disclosed in the above mentioned paper by Marc Vilain et al., influence in which a domain of a certain decision variable reduces a domain of another decision variable via a constraint equation is specified by a calculation called a constrain propagation. With the constrain propagation, a search area is efficiently narrowed down by cutting an unnecessary search range early in consideration of the mutual influence of the domains of the decision variables via the constraint equation. However, in the solution search in the constraint programming, efficiency of the search tree in a depth direction is implemented, but efficiency in a width direction such as which of branches of the search tree is searched with a priority is still at a research stage, and an algorithm effective for all cases has not been proposed. For this reason, even in the constraint programming, it is necessary to perform a dynamic search even in the width direction so that a quasi-optimum solution corresponding to an optimum solution can be found within a practical time even if it is not an optimum solution in accordance with the change in the constraint equation.

It is an object of the present invention to provide a solution search processing apparatus which is capable of obtaining a quasi-optimum solution within a practical time using learning data in a large-scale discrete optimization problem in which a solution search is performed by the constraint programming.

A configuration of a solution search processing apparatus of the present invention is preferably a solution search processing apparatus that searches for a quasi-optimum solution for an objective function of a discrete optimization problem, and includes an action-value function initializing unit that inputs search information including a history of a solution, a constraint equation, and an initial state of a selectable domain of a decision variable, sets a decision variable selected in each step and a value of the decision variable as a policy, and initializes an action-value function including the policy, a selectable domain of a decision variable before policy decision, and a selectable domain of a decision variable after the policy decision as parameters, a post transition state calculating unit that calculates a selectable domain region of the decision variable after the policy decision from the selectable domain of the decision variable before the policy decision and the policy by constrain propagation, and a search unit that receives problem information including the constraint equation and the initial state of the domain of the decision variable and information of the action-value function initialized by the action-value function initializing unit, obtains a value of a corresponding action-value function from the policy, the domain of the decision variable before the policy decision, and a domain of the action-value function after the policy decision, searches for a policy in which the action-value function is largest, and searches for an optimum solution for the problem information.

Further, in the configuration of the solution search processing apparatus, the search unit sets an improvement degree of a score for an objective function as a compensation and updates the action-value function on the basis of the compensation.

According to the present invention, it is possible to provide a solution search processing apparatus which is capable of obtaining a quasi-optimum solution within a practical time using learning data in a large-scale discrete optimization problem in which a solution search is performed by the constraint programming.

### BRIEF DESCRIPTION OF THE DRAWINGS

FIG. 1 is a hardware/software configuration diagram of a solution search processing apparatus.

FIG. 2 is a diagram illustrating an example of a matrix indicating a value selection situation.

FIG. 3 is a diagram illustrating a matrix indicating a selectable domain in step 1.

FIG. 4 is a diagram illustrating a matrix indicating a selectable domain in step 2.

FIG. 5 is a diagram illustrating a state in a search step.

FIG. 6 is a diagram illustrating a search tree according to an algorithm of the present embodiment.

FIG. 7 is a diagram illustrating a Q-learning state.

FIG. 8 is a diagram illustrating an overall overview of a process of a solution search processing apparatus.

FIG. 9A is a flowchart illustrating a search process of a solution search processing apparatus (a part thereof).

FIG. 9B is a flowchart illustrating a search process of a solution search processing apparatus (a part thereof).

### DESCRIPTION OF THE PREFERRED EMBODIMENT

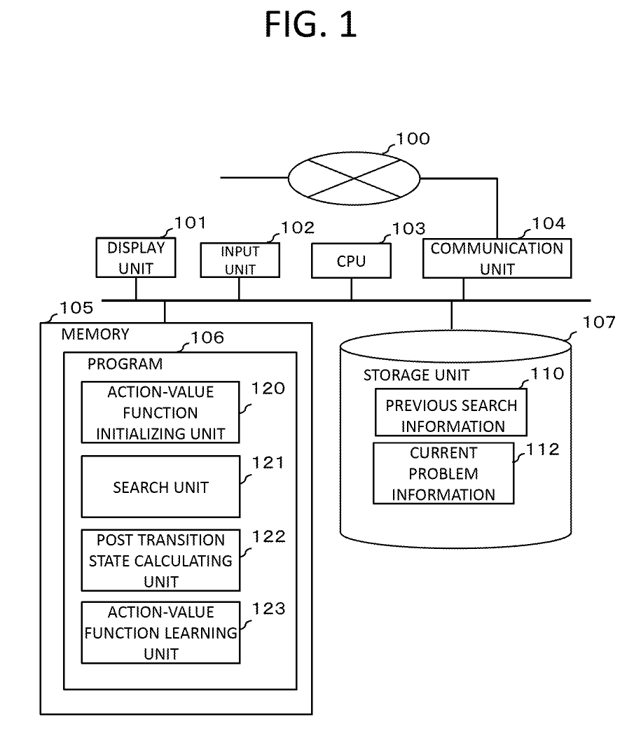

Hereinafter, embodiments according to the present invention will be described with reference to FIGS. 1 to 9B.

First, a hardware/software configuration of a solution search processing apparatus in accordance with a first embodiment will be described with reference to FIG. 1. As illustrated in FIG. 1, the solution process processing apparatus is an apparatus that automatically performs reallocation of vehicles or crew in railroad or resource placement planning and is implemented by a common information processing apparatus including a display unit 101, an input unit 102, a CPU 103, a communication unit 104, a storage unit 107, and a memory 105. The information processing apparatus used as the hardware of the solution search processing apparatus may be a desktop computer, a laptop computer, a tablet, or a server apparatus. Further, the information processing apparatus of the solution search processing apparatus can communicate with another information processing apparatus via a network 100.

The storage unit 107 stores previous search information 110 and current problem information 112. The previous search information 110 is information including a previous solution history, a constraint equation, and an initial state of a domain of a decision variable. The current problem information 112 is information including a constraint equation and an initial state of a domain of a decision variable. The previous search information 110 is used to initialize an action-value function, and the current problem information 112 is data of a problem which is a target for which a current quasi-optimum solution is obtained.

A program 106 for executing respective functions of the solution search processing apparatus is stored in the memory 105, and the functions are implemented by the program executed by the CPU 103. By executing the program 106, the solution search processing apparatus executes functions of respective functional units such as an action-value function initializing unit 120, a search unit 121, a post transition state calculating unit 122, and an action-value function learning unit 123. The function of the respective units will be described later in detail.

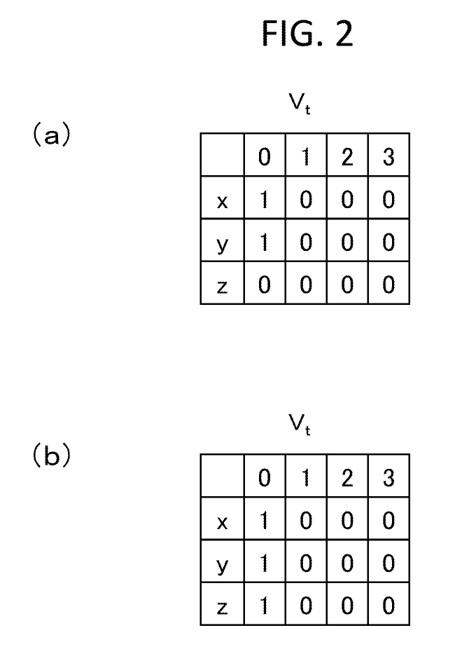

Next, a basic concept, a notation, and a discrete optimization problem taken as an example of the present embodiment will be described with reference to FIGS. 2 to 6. In the present embodiment, a discrete optimization problem for obtaining a condition of increasing a certain production yield as much as possible in production amounts of lines X, Y, and Z (respective production amounts are indicated by x, y, z and assumed to be integers) under a fixed constraint condition is considered.

Here, the following constraint condition is assumed. A production capacity of each line: 0≤x, y, z≤3

A constraint on a production facility coming from a shared facility of the lines Y and Z: 0≤y+z—3

A constraint coming from placement of workers engaged in production:

when z=3, x=0, y=0;

when z=2, x≤1;

when z=1, (x, y)=(0, 0)∪(1, 1); and

when z=0, (x, y)≠(3, 3).

At this time, a problem of maximizing a production yield f(x, y, z)=5x+3y+z. A function which is a target of an optimization problem is referred to as an objective function.

The solution search processing apparatus receives the previous search information 110 and derives a relation between the value of the decision variable selected for each search step and a selectable domain that changes in accordance with selection of the decision variable. Here, the decision variable is a variable whose value is to be decided as a target of a problem, and in the example of this problem, x, y, z which are production amounts of the respective lines are the decision variables. Further, the domain is a range (domain) of values which can be taken by the decision variable.

It is indicated by a value selection situation of each decision variable at search step t and a selectable domain, and it is noted by the following matrices:

Vₜ: a matrix indicating a value selection situation of each decision variable in a search step t; and

Dₜ: a matrix indicating a selectable domain of each decision variable in the search step t.

In the matrices Vₜ and Dₜ, rows indicate the decision variables x, y, and z, and columns indicate domains of the decision variables x, y, and z. An initial value of each element of Vₜ in the search step t=0 is 0.

In Vₜ, 1 is assumed to be selected as columns of domains 1 in rows of the decision variables x, y, and z in the search step t, where x, y, z=1 (1=0, 1, 2, and 3).

In Dₜ, for an initial value of each element in the search step t=0, the domains 1 of the decision variables x, y, and z which can be selected in the initial states of the decision variables are set to 1, and the domains 1 which are unable to be selected are set to 0. In search step t≠0, the columns of the domains 1 in the rows of the decision variables x, y, and z which can be selected by the constrain propagation from other decision variables in the state of Vₜ are updated to 1, and the columns which are unable to be selected are updated to 0.

For example, when x=y=1 is selected, and z is not selected in a certain step t, Vₜ becomes one illustrated in FIG. 2(a).

Further, when x=y=z=1 is selected in a certain step t, Vₜ becomes one illustrated in FIG. 2(b). Here, when only one 1 appears in all the rows, it means that all x, y, and z are selected.

Practically, when x=y=z=1, all of the above constraint conditions are satisfied, and the production yield at this time is f(1, 1, 1)=5×1+3×1+1=9.

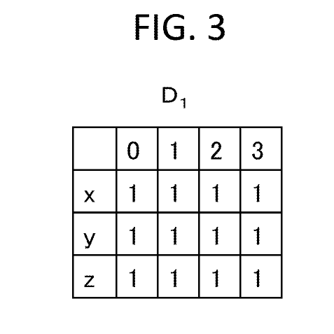

In an initial state step 1, a matrix D₁ indicating a domain when all the values can be taken is illustrated in FIG. 3.

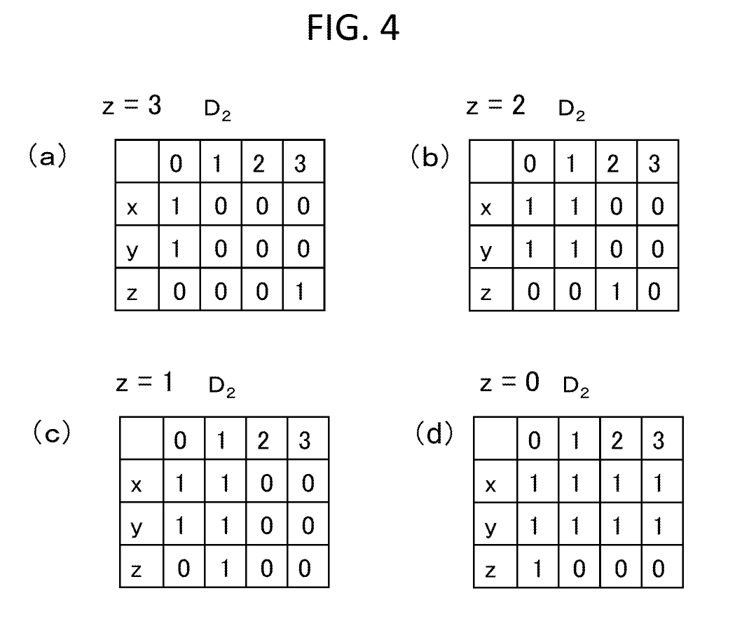

Further, in a next step 2, matrices D₂ are illustrated in FIGS. 4(a), 4(b), 4(c) and 4(d) in accordance with the value of z=3, 2, 1, and 0.

The optimum solution of the discrete optimization problem is (x, y, z)=(3, 2, 0), and the production yield is f(3, 2, 0)=5×3+3×2+0=21. A solution close to the production yield is (x, y, z)=(2, 3, 0), and the production yield is f(2, 3, 0)=5×2+3×3+0=19, and this solution may be evaluated as the quasi-optimum solution.

In such a problem, in the present embodiment, the optimum solution (quasi-optimum solution) is searched by the following algorithm. This algorithm is an application of an action-value function of Q-learning which is a sort of reinforcement learning.

The reinforcement learning is a method in which an agent (action entity) selects a certain action on the basis of a situation of an environment, a certain compensation is given to the agent with a change in the environment under the premise that the environment changes on the basis of the action, and the agent learns selection of a better action (decision making).

The Q-learning is a type of reinforcement learning, and there is a method of learning a value Q (s, a) (a value of the action-value function) for selecting a policy a under a certain environment state s. A basic idea of the Q-learning is that it is preferable to select “a” having the highest Q (s, a) as an optimum action in a certain state s.

Using the action-value function in this Q-learning, the solution search process in the solution search processing apparatus of the present embodiment is performed as follows:

1) The domain Dₜ selectable in the value selection situation Vₜ in a certain search step t is assumed to indicate the state s in the Q-learning.

2) The selectable domain Dₜ is calculated from the value selection status Vₜ by the constrain propagation.

3) A decision variable to be selected to decide the value next depending on the state s and a value thereof are indicated by a policy a.

4) An improvement degree of a score of the objective function is indicated by a compensation r.

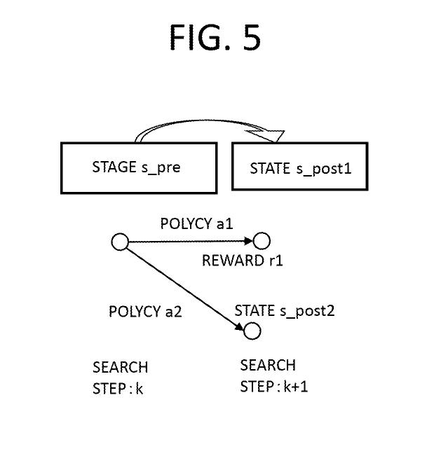

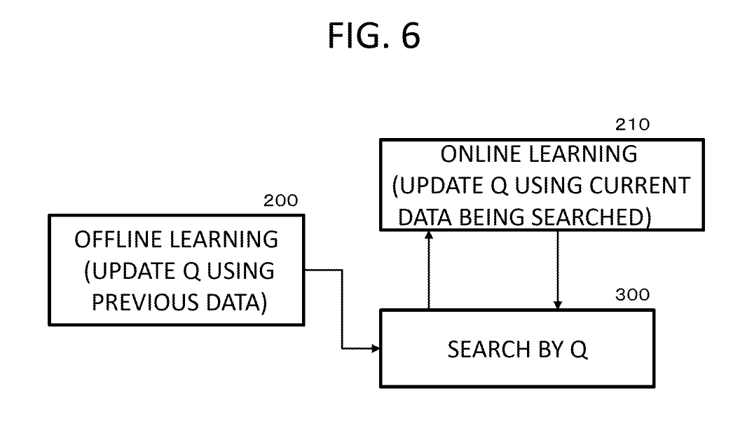

5) A selectable domain before policy decision is indicated by s_prev, a selectable domain after policy decision is indicated by s_post, and the action-value function is indicated by Q(s_pre, s_post, a) using the domains s_pre and s_post as an input, and the policy a in which the action-value function is largest is selected (FIG. 5 and FIG. 6).

6) The action-value function Q(s_pre, s_post, a) is updated by the compensation r given by the degree of improvement of the score of the objective function.

In the present embodiment, the compensation r is defined by the objective function f by Formula 1.

r=f(x₂, y₂, z₂)−f(x₁, y₁, z₁) (Formula 1)

Here, x₁, y₁, and z₁ are values before policy decision, and x₂, y₂, and z₂ are values after policy decision. This means that one in which the objective function f is large is evaluated as one in which the compensation is large in response to obtaining one in which the objective function f is largest. As in the production planning problem of the present embodiment, if the objective function is monotonic, the compensation r may be given in the middle of the solution search instead of at a time point at which the quasi-optimum solution is found.

In the initial state, the value of the action-value function Q is defined by the following Formula 2.

Q(s_pre, s_post, a)=f(x₂, y₂, z₂) (Formula 2)

Here, x₂, y₂, and z₂ are values after policy decision.

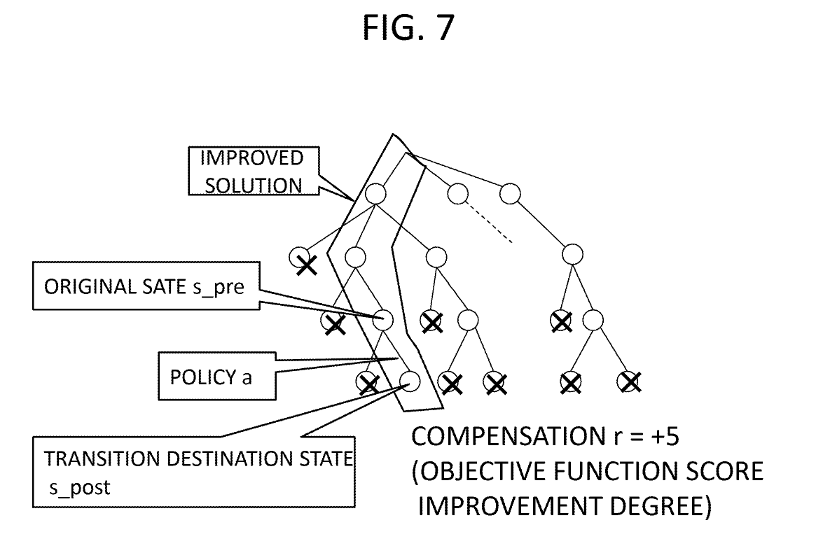

Next, a process of learning the action-value function Q will be described with reference to FIG. 7. As described above, the solution search algorithm of the present embodiment is based on the reinforcement learning, and the action-value function Q is updated by learning in accordance with the following Formula 3.

Q(s_pre, s_post, a)←Q(s_pre, s_post, a)+α[r+γmax Q(s_pre′, s_post′, c)−Q(^{c}s_pre, s_post, a)] (Formula 3)

Here, s_pre′ is a selectable domain before policy decision in the rear, s_post is a selectable domain after policy decision in the rear, and “c” is a policy candidate. Further, γ(0<γ≤1) is a discount rate, and α(0<α≤1) is a learning rate, and γ and α are constants in the Q-learning.

As a search strategy for learning, for example, an ε-greedy technique is used. It is a technique in which, when an improvement solution is searched, the search tree is searched randomly with a probability ε, and the search tree is searched so that Q is maximized with a probability 1−ε.

As the improvement solution, since one in which the action-value function is large becomes an index, it is natural to search for so that Q is maximized, but in this case, a solution search range is not widened, and there is likely to be a quasi-optimum solution or an optimum solution which is buried. For this reason, the ε-greedy technique can be regarded to be an algorithm in which a random search is combined with a search for maximizing Q.

The solution search processing apparatus of the present embodiment performs a search process 300 according to Q using offline learning 200 using the previous search information 110 and online learning 210 using the current problem information 112 as illustrated in FIG. 6.

The offline learning 200 includes imitation and enhancement processes using the previous search information 110. The imitation process is a process of updating an action-value function Q using a solution of a previous problem (training data), and the enhancement process is a process of finding a new solution to a previous problem and updating Q.

One online learning 210 is learning performed to deal with a change in the objective function or a counter example to previous data. In a case in which there is a change in the objective function or a counter example, if a solution according to the action-value function Q is searched for using the previous search information 110, a high compensation r is not obtained. For this reason, if a high compensation r is accidentally found by the ε-greedy technique with the probability ε, Q is updated so that a direction of the high compensation r found accidentally is intensively searched. Therefore, as a result of searching in accordance with the action-value function Q updated by the online learning 210, it is possible to adjust the search even in a case in which the objective function is changed or there is a counter example. Further, the Q-learning algorithm is similar between the offline learning 200 and the online learning 210.

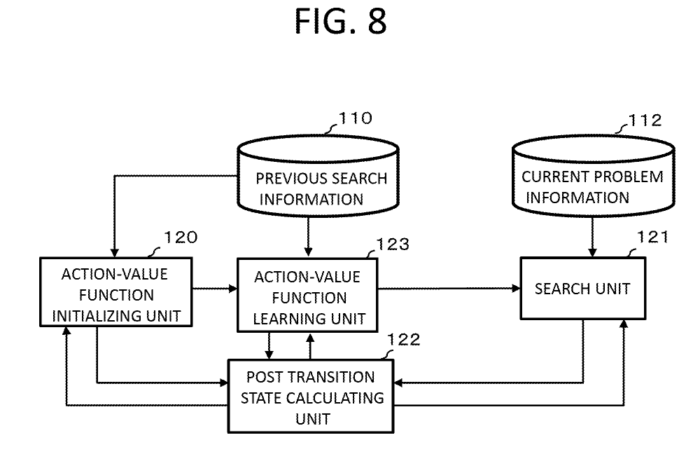

Next, an overall overview of the process of the solution search processing apparatus will be described with reference to FIG. 8. The action-value function initializing unit 120 illustrated in FIG. 8 is a functional unit that initializes the action-value function Q. The action-value function initializing unit 120 initializes the action-value function Q using a history of a problem and a solution of previous data (offline learning 200). Here, Q is updated and initialized in accordance with Formula 2 by using the score of the objective function as the compensation.

The action-value function learning unit 123 is a functional unit that learns the action-value function Q. The action-value function learning unit 123 searches for the improvement solution to the problem of the previous data for the initialized action-value function Q using the ε-greedy technique, and updates Q using the improvement degree as the compensation (the offline learning 200 (Formula 3)). Further, it is called during the search for the current problem, the improvement solution is searched for by the ε-greedy technique, and Q is updated using the improvement degree as the compensation (the online learning 210 (Formula 3)).

The search unit 121 is a functional unit that searches for a solution in accordance with the action-value function Q. The search unit 121 receives data from the current search information in accordance with the action-value function Q tuned in the offline learning 200 and searches the optimum solution and the quasi-optimum solution by taking the policy a in each step.

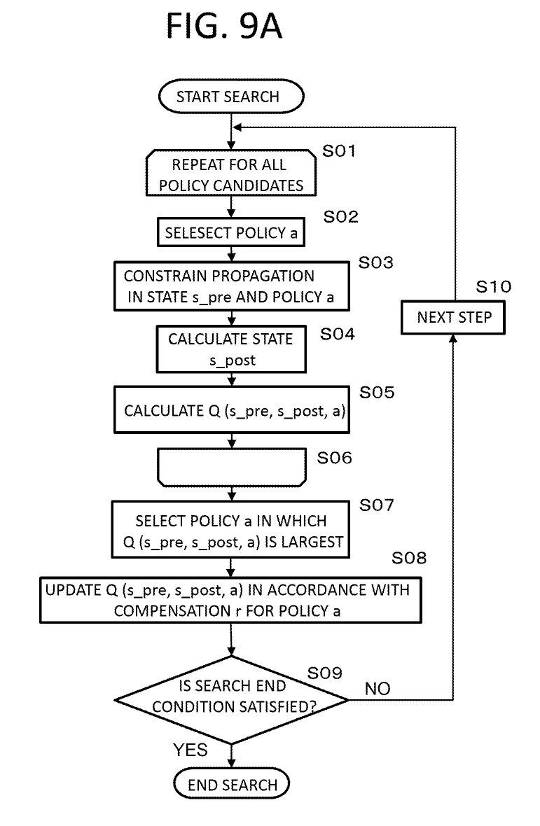

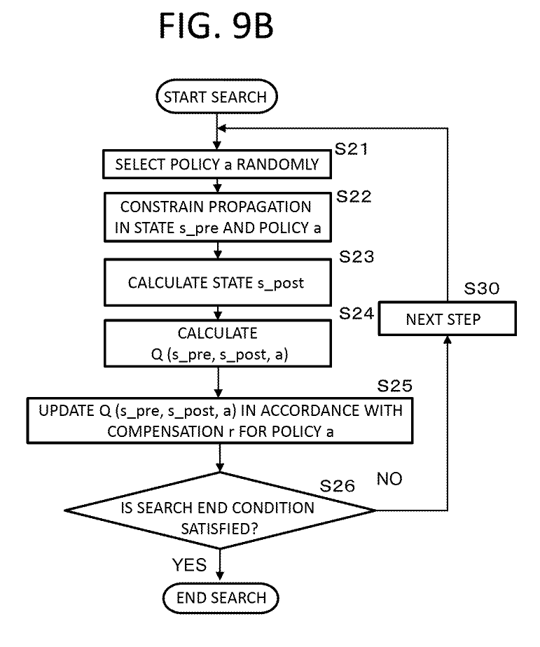

Next, the search process by the solution search processing apparatus will be described with reference to FIGS. 9A and 9B. The search process of the present embodiment is a search process under the constrain propagation using the concept of the reinforcement learning, and an example illustrated in FIG. 9A is an algorithm in which the compensation r is assigned in accordance with an interim score of the objective function (the value of the objective function) if necessary for each policy of each step, and a search is performed while updating Q. That is, the search tree is searched so that Q is maximized with the probability 1-ε using the ε-greedy technique.

The following processing is repeated for all policy candidates (S01 to S06). The policy a is selected (S02), the constrain propagation is calculated using the state s_pre and the policy a (S03), and the state s post is calculated (S04). Then, Q(s_pre, s_post, a) is calculated (S05).

When a loop of S01 to S07 is left, the policy a in which Q(s_pre, s_post, a) is largest is selected (S07) and Q(s_pre, s_post, a) is updated in accordance with the compensation r for the policy a (S08 (Formula 3)).

When the search end condition is satisfied (S09: YES), the search process ends, and when there is any solution which is not decided (S09: NO), the process proceeds to a next step (S10) and returns to S01.

The search end condition is decided in accordance with a nature of the discrete optimization problem or an intention of the user. For example, what the step number or the depth of the search tree exceeds a predetermined one, what the quasi-optimum solution is obtained, and a sufficient score is obtained by the objective function, what an operation time of a CPU of the solution search processing apparatus exceeds a predetermined time, and the like are considered.

In another search strategy, the policy a is randomly selected as illustrated in FIG. 9B. It corresponds to searching the search tree randomly with the probability ε by the ε-greedy technique.

First, the policy a is randomly selected (S21), the constrain propagation is calculated using the state s pre and the policy a (S22), and the state s post is calculated (S23). Then, Q(s_pre, s_post, a) is calculated (S24).

Then, Q(s_pre, s_post, a) is updated in accordance with the compensation r for the policy a (S26 (Formula 3)).

When the search end condition is satisfied (S26: YES), the search process ends, and when there is any solution which is not decided (S26: NO), the process proceeds to a next step (S30) and returns to S21.

As an example of the discrete optimization problem, there is a problem in which a desirable attack is calculated by giving a phase in a complete information game such as shogi, chess, and go. In this case, rules (the constraint and the objective function) of those games are fixed. Therefore, it is not necessary to change the search model if they have the same rules. On the other hand, since the constraint and the objective function in the business scheduling problem are changed each time, it is unable to be coped with by artificial intelligence for games in which the same rules are prerequisites. According to a solution search processing method of the present embodiment, even in a problem that the constraint and the objective function are changed, a selectable domain of the decision variable in which a change in the rules (particularly, the constraint) is reflected is calculated by the constrain propagation, the search is performed by the reinforcement learning model in accordance with the change in the selectable domain, and thus there is an advantage in that it is possible to efficiently search for the quasi-optimum solution in accordance with the change in the rules.

Further, in the action-value function, the number of case classifications of parameters is likely to be increased, and thus the policy a in which the action-value function Q is largest may be estimated by a convolution neural network.

In the present embodiment, the example of the reinforcement learning of updating the action-value function by the Q-learning has been described above, but the framework of the reinforcement learning is not limited to the above example, and other enhancement techniques such as Actor-Critic, Sarsa, and a Monte Carlo technique may be used.

In the present embodiment, the selectable domain s_post after decision of the policy detected as the state can be calculated by a product of the elements of the matrix of the selectable domain s post before policy decision and the matrix of the action of the constrain propagation. Further, the policy itself may be indicated by the matrix of the action of the constrain propagation.

As described above, according to the solution search processing apparatus of the present embodiment, the reinforcement learning technique is applied to the discrete optimization problem, and thus even in a case in which the constraint or the objective function is changed, the search is performed in accordance with the action-value function, and thus even when the number of possible combinations of decision variables is enormous, it is possible to obtain the quasi-optimum solution within the practical time.

1. A solution search processing apparatus that searches for a quasi-optimum solution for an objective function of a discrete optimization problem, comprising:
an action-value function initializing unit that inputs search information including a history of a solution, a constraint equation, and an initial state of a selectable domain of a decision variable, sets a decision variable selected in each step and a value of the decision variable as a policy, and initializes an action-value function including the policy, a selectable domain of a decision variable before policy decision, and a selectable domain of a decision variable after the policy decision as parameters;
a post transition state calculating unit that calculates a selectable domain region of the decision variable after the policy decision from the selectable domain of the decision variable before the policy decision and the policy by constrain propagation; and
a search unit that receives problem information including the constraint equation and the initial state of the domain of the decision variable and information of the action-value function initialized by the action-value function initializing unit, obtains a value of a corresponding action-value function from the policy, the domain of the decision variable before the policy decision, and a domain of the action-value function after the policy decision, searches for a policy in which the action-value function is largest, and searches for an optimum solution for the problem information.

2. The solution search processing apparatus according to claim 1, wherein the search unit sets an improvement degree of a score for an objective function as a compensation and updates the action-value function on the basis of the compensation.

3. The solution search processing apparatus according to claim 1, further comprising,
an action-value function learning unit that receives the search information, sets an improvement degree of a score for an objective function as a compensation, and updates the action-value function on the basis of the compensation.

4. The solution search processing apparatus according to claim 3, wherein the action-value function learning unit uses an ε-greedy technique as a selection strategy of a policy for learning the action-value function.

5. A solution search method by a solution search processing apparatus that searches for a quasi-optimum solution for an objective function of a discrete optimization problem, comprising:
a step of inputting, by the solution search processing apparatus, search information including a history of a solution, a constraint equation, and an initial state of a selectable domain of a decision variable, setting a decision variable selected in each step and a value of the decision variable as a policy, and initializing an action-value function including the policy, a selectable domain of a decision variable before policy decision, and a selectable domain of a decision variable after the policy decision as parameters;
a step of calculating, by the solution search processing apparatus, a selectable domain region of the decision variable after the policy decision from the selectable domain of the decision variable before the policy decision and the policy by constrain propagation; and
a step of receiving, by the solution search processing apparatus, problem information including the constraint equation and the initial state of the domain of the decision variable and information of the action-value function initialized by the action-value function initializing unit, obtaining a value of a corresponding action-value function from the policy, the domain of the decision variable before the policy decision, and a domain of the action-value function after the policy decision, searching for a policy in which the action-value function is largest, and searching for an optimum solution for the problem information.

6. The solution search processing method according to claim 5, wherein, in the step of searching for the optimum solution for the problem information, an improvement degree of a score for an objective function is set as a compensation, and the action-value function is updated on the basis of the compensation.

7. The solution search processing method according to claim 5, further comprising,
a step of receiving the search information, setting an improvement degree of a score for an objective function as a compensation, and updating the action-value function on the basis of the compensation.

8. The solution search processing method according to claim 7, wherein, the step of updating the action-value function, an ε-greedy technique is used as a selection strategy of a policy for learning the action-value function.
